(19) United States
(12) Patent Application Publication
(10) Pub. No.: US 2025/0233372 A1
(43) Pub. Date: Jul. 17, 2025

(54) ELECTRICAL CONNECTOR

(71) Applicant: CHENG UEI PRECISION INDUSTRY CO., LTD., New Taipei City (TW)

(72) Inventors: YUN-FENG ZHANG, Dong-Guan City (CN); ZHI-BIN DONG, Dong-Guan City (CN); CHEN SUN, Dong-Guan City (CN)

(21) Appl. No.: 18/803,714

(22) Filed: Aug. 13, 2024

(30) Foreign Application Priority Data
Jan. 16, 2024 (CN) 202420112418.0

(51) Int. Cl. H01R 13/66; H01R 13/05; H01R 13/502; H01R 13/652; H01R 13/6581

(52) U.S. Cl. CPC H01R 13/6683; H01R 13/05; H01R 13/502; H01R 13/652; H01R 13/6581

(57) ABSTRACT

An electrical connector includes an insulating housing, a plurality of conductive terminals and two detecting terminals. The plurality of the conductive terminals are fastened in the insulating housing. Each conductive terminal has a first fastening portion. A front end of the first fastening portion extends frontward to form a contacting portion. The contacting portion is exposed to a front end of the insulating housing. The plurality of the conductive terminals include two power terminals and a plurality of signal terminals. The two detecting terminals are fastened in the insulating housing. Each detecting terminal is disposed between one signal terminal and one power terminal.

### CROSS REFERENCE TO RELATED APPLICATIONS

The present application is based on, and claims priority from, China Patent Application No. 202420112418.0, filed Jan. 16, 2024, the disclosure of which is hereby incorporated by reference herein in its entirety.

### BACKGROUND OF THE INVENTION

### Field of the Invention

The present invention generally relates to an electrical connector, and more particularly to an electrical connector having a higher detection sensitivity and a better safety protection performance.

### Description of Related Art

In various electrical connector types which are frequently used by various electronic products, universal serial bus (USB) connectors are the most widely applied connectors. With the improvement of science and technologies, more and more kinds of the universal serial bus connectors are developed, such as USB 2.0, USB 3.0, Micro USB, Mini USB or USB Type-C. USB Type-C connectors have been widely applied in the various electronic products.

Nevertheless, when a user uses the various electronic products, the user often touches water or other liquids accidentally to cause the water or the other liquids to be attached to electrical connectors of the various electronic products. Moreover, if the electrical connector is charged before the electrical connector is completely dried, a corrosion of a copper material of the electrical connector is aggravated, consequently, the electrical connector causes a danger in use.

A conventional electrical connector includes an insulation body, a main plate, two side plates, a plurality of terminals and a shell. The conventional electrical connector is assembled to a circuit board. The circuit board has a detection circuit. The insulation body has at least one aperture penetrating through an upper surface and a lower surface of the insulation body. The main plate is fastened in the insulation body. The two side plates are fastened in the insulation body. The two side plates are disposed to two sides of the main plate. The side plate is separated from the main plate. The main plate is connected to the detection circuit. The main plate has two first protruding portions. The two side plates have two second protruding portions. The two second protruding portions of the two side plates are corresponding to the two first protruding portions of the main plate in the at least one aperture of the insulation body. The two first protruding portions and the two second protruding portions are exposed to an outside of the insulation body through the at least one aperture. The plurality of the terminals are mounted in the insulation body. The shell is fastened to a rear end of the insulation body. The two side plates are connected to the shell. The shell is connected to ground.

However, the conventional electrical connector is designed to be appropriated for a severe water entering condition of the conventional electrical connector. The severe water entering condition of the conventional electrical connector includes a condition of falling into water, etc. When the water flows into the at least one aperture, the main plate and the two side plates touch the water, the two first protruding portions of the main plate and the two second protruding portions of the two side plates form an electrical conduction, at the moment, the main plate is electrically connected with the two side plates, and the main plate is connected to the shell, so the detection circuit detects that the main plate is connected to the ground to send a signal to the conventional electrical connector, in this way, the conventional electrical connector stops working by a complex detecting process of the conventional electrical connector. When less water enters the conventional electrical connector, the water is without entering into the at least one aperture, the water is attached on a surface of the insulation body, so that the main plate and the two side plates are without touching the water, and the main plate and the two side plates are without forming the electrical conduction, in that case, the conventional electrical connector still works to hardly protect the conventional electrical connector. As a result, the conventional electrical connector has a lower detection sensitivity.

Thus, it is essential to provide an innovative electrical connector, the innovative electrical connector having a higher detection sensitivity and a better safety protection performance.

### BRIEF SUMMARY OF THE INVENTION

An object of the present invention is to provide an electrical connector having a higher detection sensitivity and a better safety protection performance. The electrical connector includes an insulating housing, a plurality of conductive terminals and two detecting terminals. The plurality of the conductive terminals are fastened in the insulating housing. Each conductive terminal has a first fastening portion. A front end of the first fastening portion extends frontward to form a contacting portion. The contacting portion is exposed to a front end of the insulating housing. The plurality of the conductive terminals include two power terminals and a plurality of signal terminals. Two first curve portions are formed between two front ends of the two first fastening portions of two signal terminals and two rear ends of the two contacting portions of the two signal terminals. Two second curve portions are formed between the two rear ends of the two contacting portions and the two front ends of the two first fastening portions of the two power terminals. The two detecting terminals are fastened in the insulating housing. Each detecting terminal is disposed between one signal terminal and one power terminal. Each detecting terminal has a second fastening portion. A front end of the second fastening portion extends frontward and expands outward to form a detecting portion. The detecting portion is exposed to the front end of the insulating housing. Two rear ends of the two second fastening portions of the two detecting terminals and rear ends of the plurality of the first fastening portions of the plurality of the conductive terminals are aligned along a transverse direction. The front ends of the two second fastening portions of the two detecting terminals are corresponding to the front ends of the plurality of the first fastening portions of the plurality of the conductive terminals along the transverse direction. The two detecting portions of the two detecting terminals are disposed corresponding to rear ends of the plurality of the contacting portions of the plurality of the conductive terminals along the transverse direction. Two opposite sides of the detecting portion of each detecting terminal are located between the first curve portion of the one signal terminal and the second curve portion of the one power terminal. The first curve portion and the second curve portion which are located to the two opposite sides of the detecting portion of each detecting terminal are disposed opposite to each other along the transverse direction.

Another object of the present invention is to provide an electrical connector. The electrical connector includes an insulating housing, a plurality of conductive terminals arranged in a column along a transverse direction, and two detecting terminals. The insulating housing has a tongue portion, a protruding board and a base body arranged along an insertion direction. The plurality of the conductive terminals are fastened in the base body. The plurality of the conductive terminals are exposed to the tongue portion. The two detecting terminals fastened in the base body. The two detecting terminals are disposed among the plurality of the conductive terminals. The two detecting terminals are arranged in the column. Edges of the two detecting terminals face edges of adjacent conductive terminals. Each detecting terminal has a detecting portion. A front of the detecting portion is exposed to the tongue portion. A rear of the detecting portion hidden in the protruding board. A width of the detecting portion of each detecting terminal is wider than a width of each conductive terminal. At least one of the conductive terminals which is adjacent to each of the two detecting terminals has a lacking groove avoiding the detecting portion, a front of the lacking groove is exposed to the tongue portion, a rear of the lacking groove is hidden in the protruding board.

Another object of the present invention is to provide an electrical connector. The electrical connector includes an insulating housing, a plurality of conductive terminals, a center grounding plate and two detecting terminals. The insulating housing has a base body and a tongue portion. The plurality of the conductive terminals fastened in the base body. The plurality of the conductive terminals are exposed to the tongue portion. The plurality of the conductive terminals have a plurality of upper terminals and a plurality of lower terminals. The plurality of the upper terminals and the plurality of the lower terminals are arranged in two columns along a transverse direction. The center grounding plate fastened in the base body and the tongue portion. The center grounding plate is disposed between the plurality of the upper terminals and the plurality of the lower terminals. The center grounding plate has two inserting holes. The two inserting holes penetrate through opposite surfaces of the center grounding plate. The two detecting terminals arranged in each column of the conductive terminals. Each detecting terminal has a detecting portion are exposed to the tongue portion. The two detecting portions of the two detecting terminals in the column of the plurality of the upper terminals align with the two detecting portions of the two detecting terminals in the column of the plurality of the lower terminals through the two inserting holes. A width of the detecting portion of each detecting terminal is wider than a width of each conductive terminal.

As described above, the two detecting terminals are disposed between the two power terminals, the detecting portion of each detecting terminal is shown as an elliptical plate shape for increasing a detecting area and increasing a detecting effect. Furthermore, when water flows into the electrical connector, an electric capacity of the electrical connector is increased. When each detecting terminal detects that the electric capacity of the electrical connector is changed, the electrical connector stops charging or transmitting signals, so the electrical connector stops working under a condition of the water entering the electrical connector to protect the electrical connector. As a result, the electrical connector has a higher detection sensitivity and a better safety protection performance so as to effectively protect the electrical connector and a user.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with the present invention;

FIG. 2 is a partially exploded view showing an insulation body, a metal shell assembly, two metal elements, and an insulating housing together with a terminal assembly, a center grounding plate, two shielding plates and a glue body of the electrical connector of FIG. 1;

FIG. 3 is another partially exploded view showing the insulating housing, an upper shielding plate, a lower shielding plate, the glue body, and the terminal assembly together with the center grounding plate of the electrical connector of FIG. 1;

FIG. 4 is an exploded view of an upper terminal assembly of the electrical connector of FIG. 1;

FIG. 5 is another exploded view of the upper terminal assembly of the electrical connector of FIG. 1;

FIG. 6 is an enlarged view of an encircled portion X1 of the upper terminal assembly of the electrical connector of FIG. 5;

FIG. 7 is an exploded view of a lower terminal assembly of the electrical connector of FIG. 1;

FIG. 8 is another exploded view of the lower terminal assembly of the electrical connector of FIG. 1;

FIG. 9 is an enlarged view of an encircled portion X2 of the lower terminal assembly of the electrical connector of FIG. 8;

FIG. 10 is a perspective view of the center grounding plate of the electrical connector of FIG. 1;

FIG. 11 is a partially diagrammatic drawing of the electrical connector of FIG. 1; and

FIG. 12 is a partially sectional view of the electrical connector along a line XII-XII of FIG. 11.

### DETAILED DESCRIPTION OF THE INVENTION

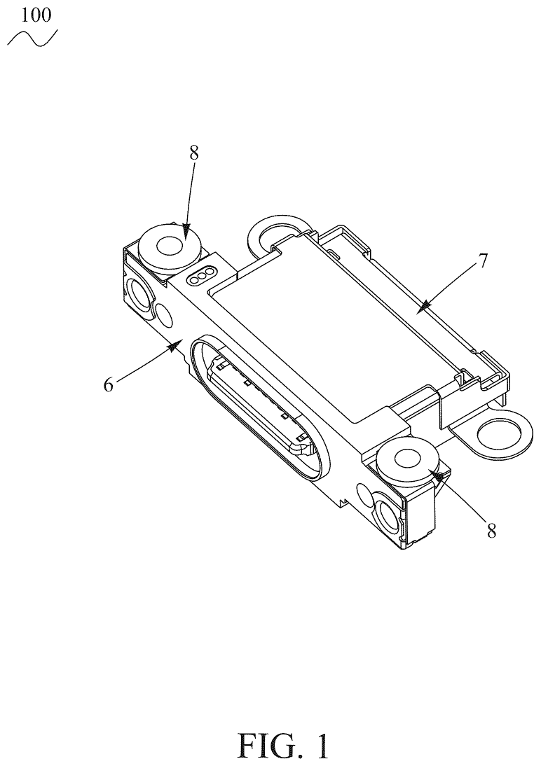

With reference to FIG. 1 to FIG. 3, an electrical connector 100 in accordance with the present invention is shown. The electrical connector 100 includes an insulating housing 1, a terminal assembly 2, a center grounding plate 3, two shielding plates 4, a glue body 5, an insulation body 6, a metal shell assembly 7 and two metal elements 8. In the present invention, the electrical connector 100 is a USB (Universal Serial Bus) Type-C connector. In a concrete implementation, the electrical connector 100 is able to be another type connector which is different from the USB Type-C connector.

The insulating housing 1 surrounds the terminal assembly 2 and the center grounding plate 3. The terminal assembly 2 is fastened in the insulating housing 1. The center grounding plate 3 is fastened to a middle of the terminal assembly 2. The center grounding plate 3 is fastened in the insulating housing 1. The two shielding plates 4 are mounted in an upper portion and a lower portion of the insulating housing 1. The glue body 5 encloses a rear end of the insulating housing 1. The glue body 5 is mounted to a rear end of the insulation body 6. The glue body 5 is covered to the rear end of the insulation body 6. The glue body 5 seals up an interval between the insulating housing 1 and the insulation body 6 for preventing water flowing into a rear end of the electrical connector 100 to damage the electrical connector 100. The insulating housing 1 is fastened in the insulation body 6. The metal shell assembly 7 is fastened to an upper surface and a lower surface of the insulation body 6. The metal shell assembly 7 is used for shielding an interference, and the metal shell assembly 7 is used for being connected to ground. The two metal elements 8 are respectively mounted to two opposite sides of the insulation body 6.

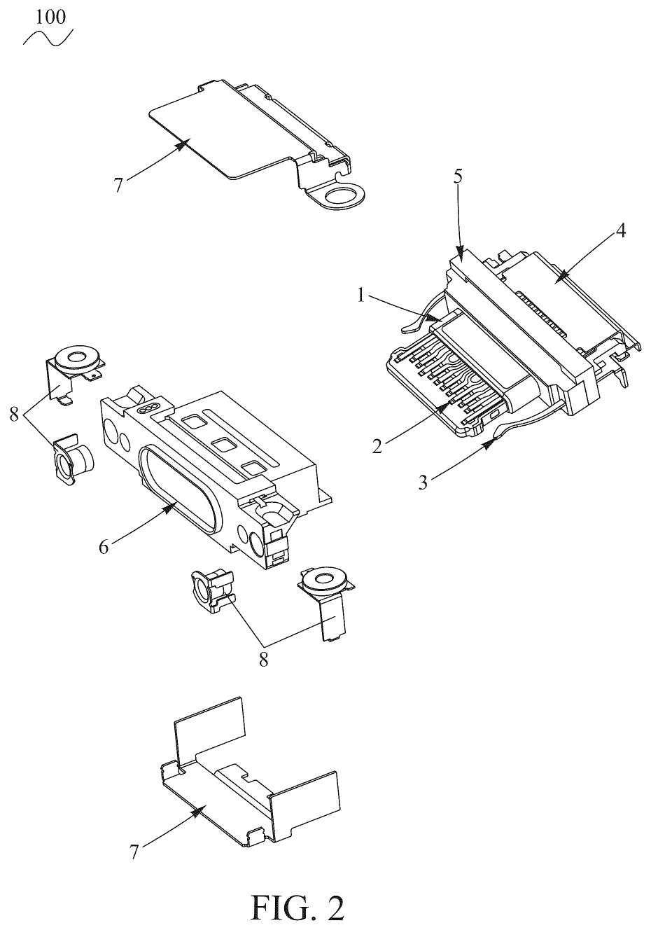

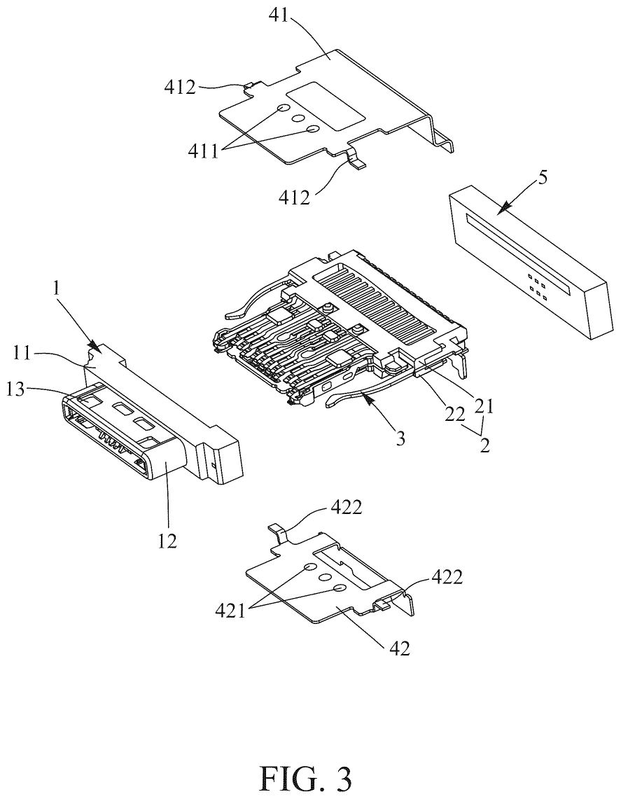

Referring to FIG. 2 and FIG. 3, the insulating housing 1 has a base body 11, a protruding board 12 and a plurality of through holes 13. A middle of a front surface of the base body 11 extends frontward to form the protruding board 12. The protruding board 12 is shown as a hollow shape. An upper portion and a lower portion of the protruding board 12 have the plurality of the through holes 13 penetrating through a top surface and a bottom surface of the protruding board 12. Corresponding mechanisms of the terminal assembly 2 are disposed in the plurality of the through holes 13. When the insulating housing 1 is formed, the corresponding mechanisms of the terminal assembly 2 are used for supporting corresponding mechanisms of the two shielding plates 4 to avoid an encapsulation problem of the two shielding plates 4.

Referring to FIG. 2 and FIG. 3, the terminal assembly 2 is disposed in the insulating housing 1. The terminal assembly 2 includes an upper terminal assembly 21 fastened in the insulating housing 1, and a lower terminal assembly 22 fastened in the insulating housing 1. The upper terminal assembly 21 is disposed on a top surface of the center grounding plate 3. The lower terminal assembly 22 is disposed under a bottom surface of the center grounding plate 3. The center grounding plate 3 is disposed between the upper terminal assembly 21 and the lower terminal assembly 22.

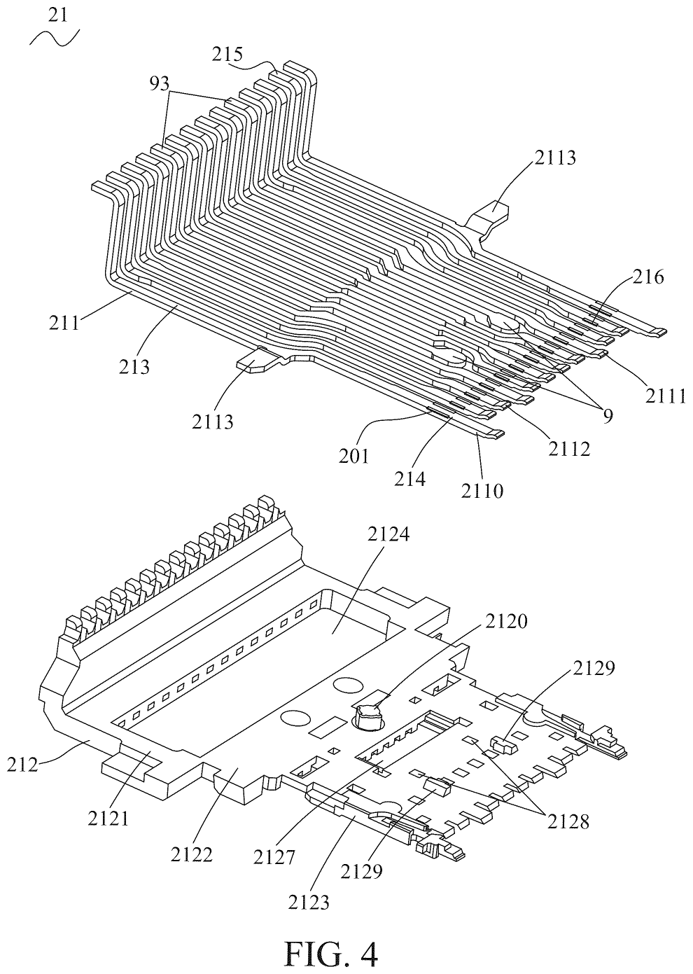

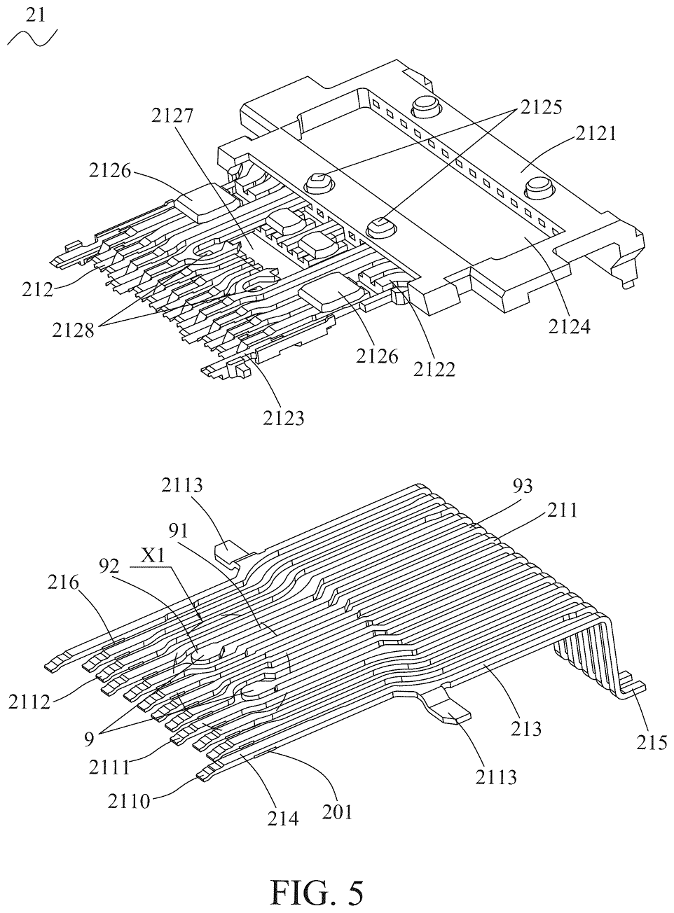

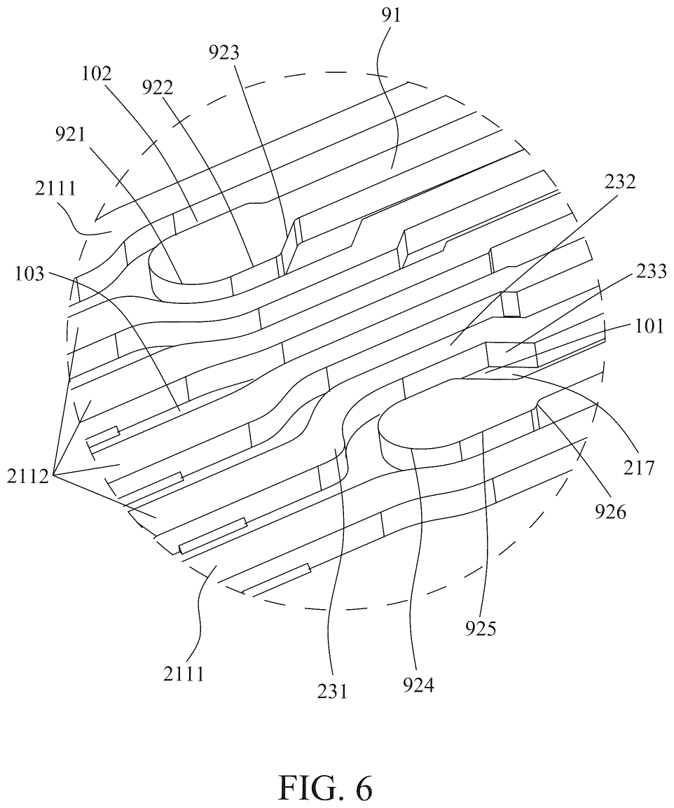

Referring to FIG. 4 to FIG. 6, the upper terminal assembly 21 of the electrical connector 100 includes a plurality of conductive terminals 211, two detecting terminals 9, and an insulating body 212 mounted in the insulating housing 1. The plurality of the conductive terminals 211 are fastened in the insulating body 212. The plurality of the conductive terminals 211 together with the insulating body 212 are fastened in the insulating housing 1. Each conductive terminal 211 has a first fastening portion 213, a contacting portion 214 and a first soldering portion 215. The first fastening portion 213 is disposed in the insulating body 212. The first fastening portion 213 is elongated. A rear end of the contacting portion 214 extends rearward to form the first fastening portion 213. The rear end of the contacting portion 214 extends rearward, then slantwise extends outward and rearward, and further extends rearward to form the first fastening portion 213. A front end of the first fastening portion 213 extends frontward to form the contacting portion 214. A rear end of the first fastening portion 213 extends downward and then is bent rearward to form the first soldering portion 215. The contacting portions 214 of the plurality of the conductive terminals 211 are exposed to a front end of the insulating housing 1. The contacting portion 214 has two triangular protruding blocks 201. Each protruding block 201 is connected between a lower portion of one side surface and a bottom surface of the contacting portion 214. An outer surface and an inner surface of each protruding block 201 slantwise extend downward and outward to form two chamfers 216. Each chamfer 216 is used for reducing a degumming risk of the upper terminal assembly 21 to reinforce an impact resistance performance.

The two detecting terminals 9 are fastened in the insulating body 212. The two detecting terminals 9 together with the insulating body 212 are fastened in the insulating housing 1. The two detecting terminals 9 are disposed among the plurality of the conductive terminals 211. Each detecting terminal 9 has a second fastening portion 91, a detecting portion 92 and a second soldering portion 93. The detecting portion 92 is fastened in the insulating body 212. The second fastening portion 91 is elongated. A rear end of the detecting portion 92 extends rearward to form the second fastening portion 91. The rear end of the detecting portion 92 extends rearward, then slantwise extends outward and rearward and further extends rearward to form the second fastening portion 91. A front end of the second fastening portion 91 extends frontward and expands outward to form the detecting portion 92. A rear end of the second fastening portion 91 extends downward and then is bent rearward to form the second soldering portion 93. The detecting portion 92 is exposed to the front end of the insulating housing 1. A width of the detecting portion 92 of each detecting terminal 9 is wider than a width of the second fastening portion 91 of each detecting terminal 9. The width of the detecting portion 92 of each detecting terminal 9 is wider than a width of the contacting portion 214 of each conductive terminal 211. The width of the detecting portion 92 of each detecting terminal 9 is wider than a width of the first fastening portion 213 of each conductive terminal 211. the detecting portion 92 of each detecting terminal 9 is shown as an elliptical plate shape. The elliptical plate shape of the detecting portion 92 is used for increasing a detecting area and increasing a detecting effect.

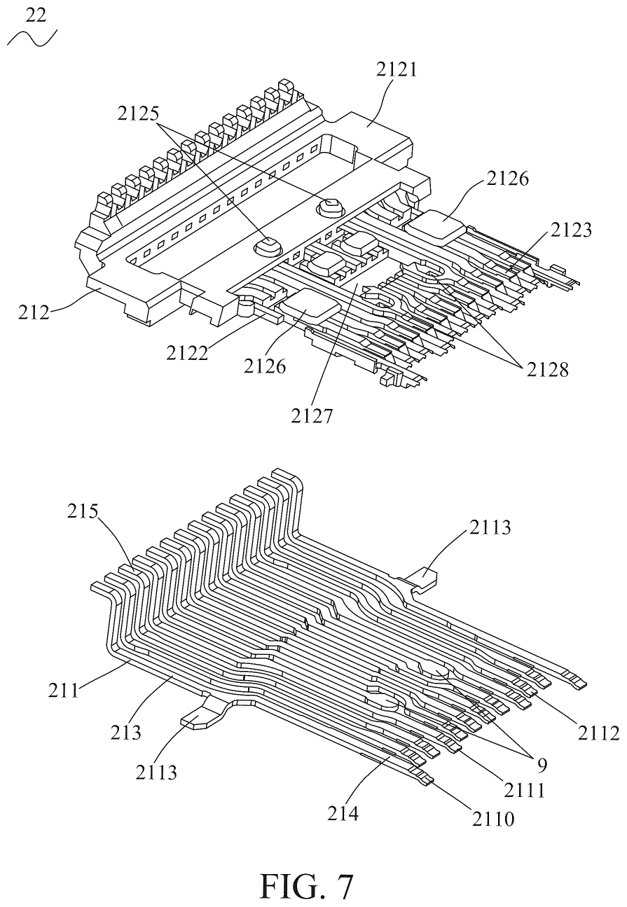

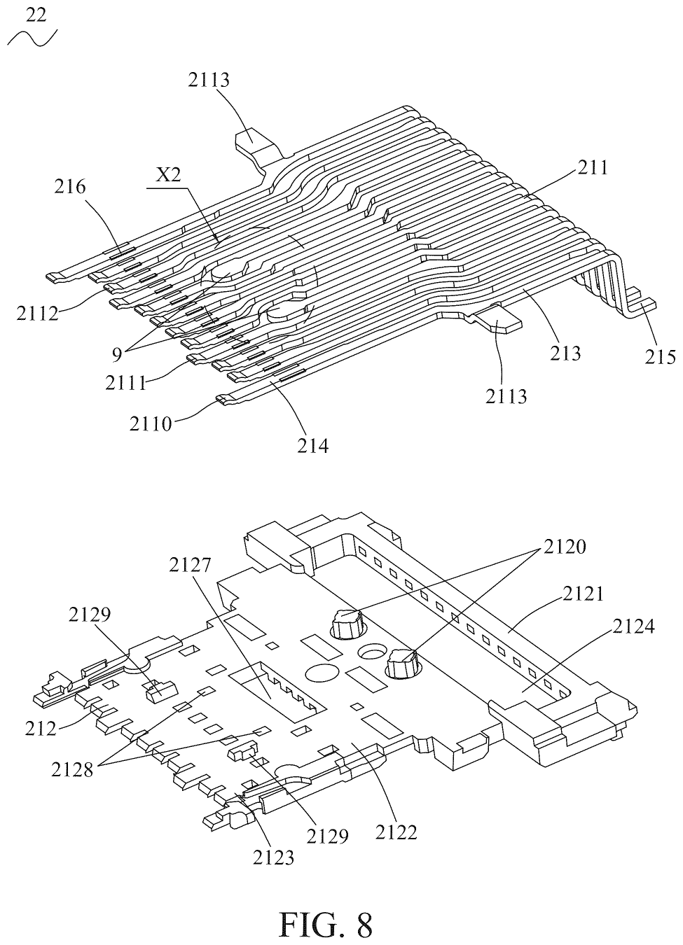

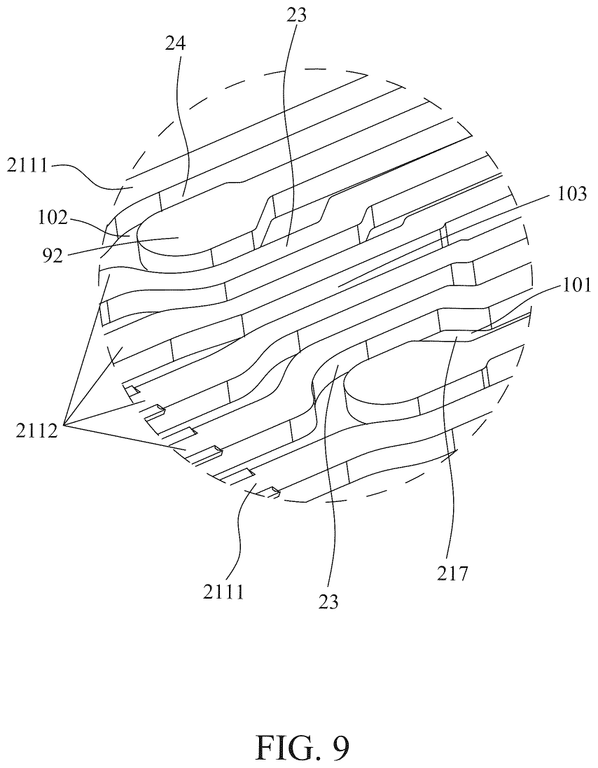

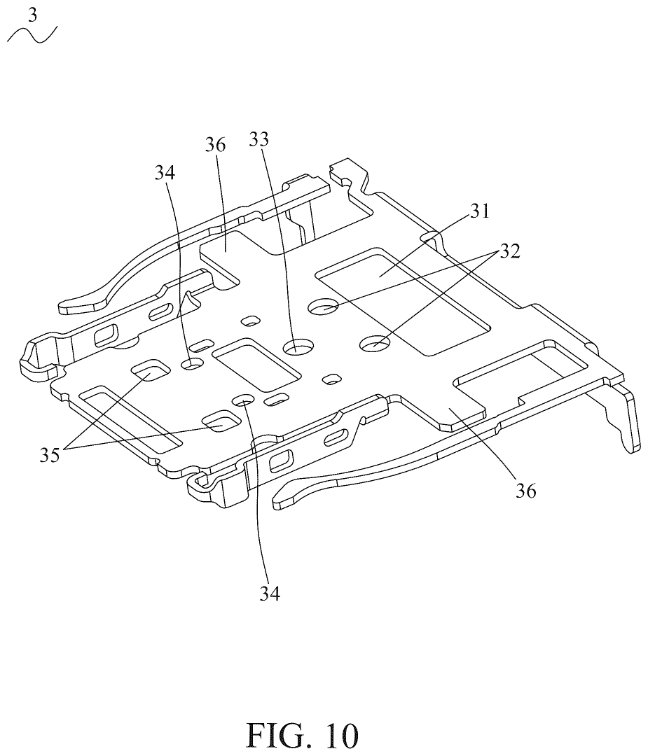

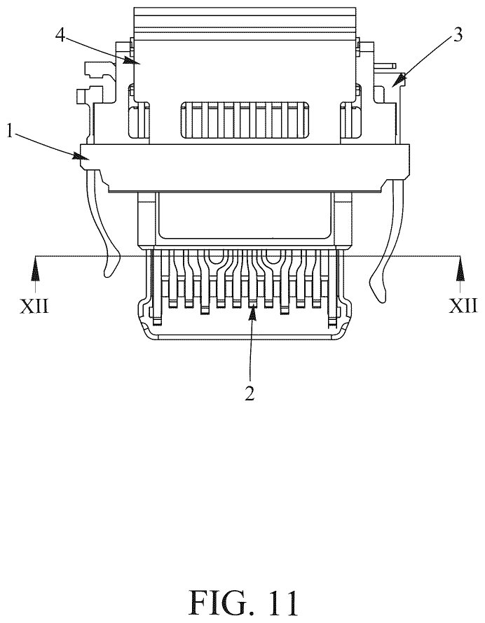

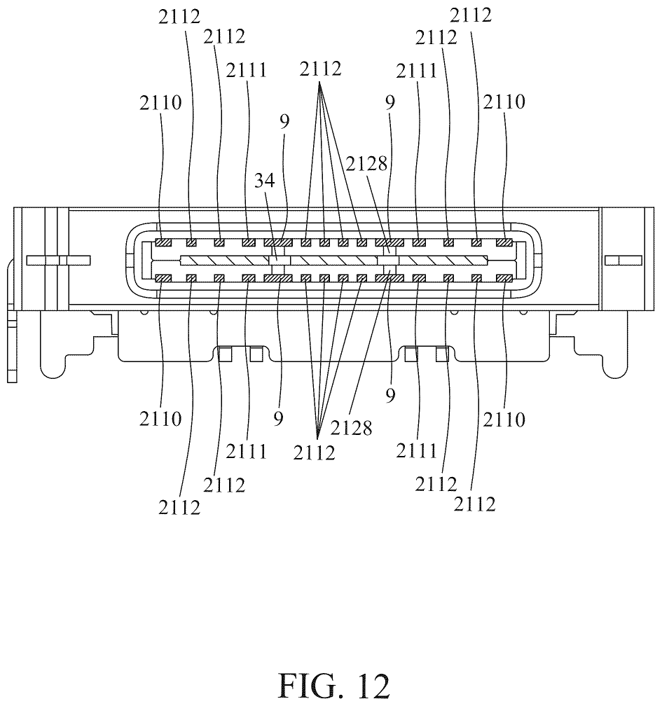

Referring to FIG. 4 to FIG. 12, the plurality of the conductive terminals 211 include two grounding terminals 2110, two power terminals 2111 and a plurality of signal terminals 2112. When the electrical connector 100 is the USB (Universal Serial Bus) Type-C connector, the electrical connector 100 has twelve pins. The twelve pins are defined from a first pin to a twelfth pin. The twelve pins which are from the first pin to the twelfth pin are the grounding terminal 2110, the signal terminal 2112, the signal terminal 2112, the power terminal 2111, the signal terminal 2112, the signal terminal 2112, the signal terminal 2112, the signal terminal 2112, the power terminal 2111, the signal terminal 2112, the signal terminal 2112 and the grounding terminal 2110 in sequence. One detecting terminal 9 is disposed between a fourth pin and a fifth pin of the electrical connector 100. The other detecting terminal 9 is disposed between a ninth pin and a tenth pin of the electrical connector 100, so each detecting terminal 9 is disposed between one signal terminal 2112 and one power terminal 2111. Two signal terminals 2112 are located between the two detecting terminals 9. The two signal terminals 2112 and the two detecting terminals 9 are located between two power terminals 2111. The upper terminal assembly 21 has twelve conductive terminals 211 which are the twelve pins, and the two detecting terminals 9. The twelve conductive terminals 211 are disposed at two sides of the insulating body 212. Six conductive terminals 211 of one side of the insulating body 212 are opposite to six conductive terminals 211 of the other side of the insulating body 212. The two detecting terminals 9 are used for detecting a variation of an electric capacity of the electrical connector 100.

The rear ends of the plurality of the contacting portions 214 of the plurality of the conductive terminals 211 are aligned along a transverse direction. Front ends of the plurality of the contacting portions 214 of the plurality of the conductive terminals 211 are corresponding to one another along the transverse direction. Rear ends of the plurality of the first fastening portions 213 of the plurality of the conductive terminals 211 are aligned along the transverse direction. Front ends of the plurality of the first fastening portions 213 of the plurality of the conductive terminals 211 are corresponding to one another along the transverse direction. The plurality of the first soldering portions 215 of the plurality of the conductive terminals 211 are aligned along the transverse direction.

The two detecting portions 92 of the two detecting terminals 9 are located among the rear ends of the plurality of the contacting portions 214 of the plurality of the conductive terminals 211. The two detecting terminals 9 are spaced from each other. Each detecting terminal 9 is disposed between two adjacent conductive terminals 211. The two detecting portions 92 of the two detecting terminals 9 are disposed corresponding to the rear ends of the plurality of the contacting portions 214 of the plurality of the conductive terminals 211 along the transverse direction. The two detecting portions 92 of the two detecting terminals 9 are disposed to the front ends of the plurality of the first fastening portions 213 of the plurality of the conductive terminals 211. Two rear ends of the two second fastening portions 91 of the two detecting terminals 9 and the rear ends of the plurality of the first fastening portions 213 of the plurality of the conductive terminals 211 are aligned along the transverse direction. The front ends of the two second fastening portions 91 of the two detecting terminals 9 are corresponding to the front ends of the plurality of the first fastening portions 213 of the plurality of the conductive terminals 211 along the transverse direction. The two second soldering portions 93 of the two detecting terminals 9 and the plurality of the first soldering portions 215 of the plurality of the conductive terminals 211 are aligned along the transverse direction.

The width of the detecting portion 92 of each detecting terminal 9 is wider than a width of each conductive terminal 211. Two opposite sides of each detecting terminal 9 face towards two side surfaces of the one signal terminal 2112 and the one power terminal 2111. Two fronts of the two side surfaces of the one signal terminal 2112 and the one power terminal 2111 are recessed oppositely to form a first curve portion 23 and a second curve portion 24. Two first curve portions 23 of the two signal terminals 2112 are located between the two detecting terminals 9. The two detecting terminals 9 are located between the two second curve portions 24 of the two power terminals 2111. The two first curve portions 23 of the two signal terminals 2112 are located to two sides of the two detecting portions 92 of the two detecting terminals 9. The two first curve portions 23 of the two signal terminals 2112 avoid the two sides of the two detecting portions 92 of the two detecting terminals 9. The two second curve portions 24 of the two power terminals 2111 are located to the other two sides of the two detecting portions 92 of the two detecting terminals 9. The two second curve portions 24 of the two power terminals 2111 avoid the other two sides of the two detecting portions 92 of the two detecting terminals 9. The first curve portion 23 and the second curve portion 24 are used for avoiding that the detecting portion 92 of each detecting terminal 9 is interfered with the plurality of the conductive terminals 211 in structures and electrical characteristics of the two detecting terminals 9 and the plurality of the conductive terminals 211.

The two first curve portions 23 of the two signal terminals 2112 are disposed at two rear ends of the two contacting portions 214 of the two signal terminals 2112. The two first curve portions 23 are formed between the two front ends of the two first fastening portions 213 of the two signal terminals 2112 and the two rear ends of the two contacting portions 214 of the two signal terminals 2112. The two second curve portions 24 of the two power terminals 2111 are disposed at the two rear ends of the two contacting portions 214 of the two power terminals 2111. The two second curve portions 24 are formed between the two rear ends of the two contacting portions 214 and the two front ends of the two first fastening portions 213 of the two power terminals 2111. Two opposite sides of the detecting portion 92 of each detecting terminal 9 are located between the first curve portion 23 of the one signal terminal 2112 and the second curve portion 24 of the one power terminal 2111. The two first curve portions 23 are disposed opposite to each other. The two second curve portions 24 are disposed opposite to each other. The first curve portion 23 and the second curve portion 24 which are located to the two opposite sides of the detecting portion 92 of each detecting terminal 9 are disposed opposite to each other along the transverse direction.

The contacting portion 214 of the signal terminal 2112 which has the first curve portion 23 has a first bending portion 231, an extending portion 232 and a second bending portion 233. Two fronts of the two rear ends of the two contacting portions 214 of the two signal terminals 2112 slantwise extend rearward and away from the two detecting terminals 9 to form two first bending portions 231. Two rear ends of the two first bending portions 231 extend rearward to form two extending portions 232. Two rear ends of the two extending portions 232 slantwise extend rearward and away from the two first bending portions 231 to form two second bending portions 233. The first bending portion 231, the extending portion 232 and the second bending portion 233 together form the first curve portion 23. The first bending portion 231, the extending portion 232 and the second bending portion 233 of the first curve portion 23 is shown as a C shape. Two rear ends of the two second bending portions 233 extend rearward to form the two first fastening portions 213 of the two signal terminals 2112.

Two fronts of the two rear ends of the two contacting portions 214 of the two power terminals 2111 are bent rearward and away from the two detecting terminals 9 to form the two second curve portions 24. Two rear ends of the two second curve portions 24 extend rearward to form the two first fastening portions 213 of the two power terminals 2111.

One side edge of the detecting portion 92 of each detecting terminal 9 has a first protruding edge 921, a first connecting edge 922 and a first inclining edge 923 which are sequentially arranged along a front-to-rear direction. A front end of the one side edge of the detecting portion 92 protrudes towards the first bending portion 231 to form the first protruding edge 921. A rear end of the first protruding edge 921 extends rearward to form the first connecting edge 922. A rear end of the first connecting edge 922 slantwise extends rearward and away from the extending portion 232 to form the first inclining edge 923. The first curve portion 23 of each of the two signal terminals 2112 surrounds the one side edge of the detecting portion 92 of the one detecting terminal 9. The first curve portion 23 of each of the two signal terminals 2112 is spaced from the one side edge of the detecting portion 92 of the one detecting terminal 9.

The two first protruding edges 921 of the two detecting terminals 9 are corresponding to the two first bending portions 231 of the two signal terminals 2112. The first connecting edge 922, the first inclining edge 923 and the front end of the second fastening portion 91 of each detecting terminal 9 are corresponding to the extending portion 232 and the second bending portion 233 of the one signal terminal 2112 along the transverse direction. The first connecting edge 922 is parallel to the extending portion 232. The first inclining edge 923 is parallel to the second bending portion 233. A design of the first inclining edge 923 of the detecting portion 92 of each detecting terminal 9 provides a convenience for a structure shaping of the detecting terminal 9. In the concrete implementation, the design of the first inclining edge 923 of the detecting portion 92 of each detecting terminal 9 is without being limited to provide the convenience for the structure shaping of the detecting terminal 9.

The other side edge of the detecting portion 92 has a second protruding edge 924, a second connecting edge 925 and a second inclining edge 926 which are sequentially arranged along the front-to-rear direction. A front end of the other side edge of the detecting portion 92 protrudes towards the second curve portion 24 to form the second protruding edge 924. A rear end of the second protruding edge 924 extends rearward to form the second connecting edge 925. A rear end of the second connecting edge 925 slantwise extends rearward and away from the second curve portion 24 to form the second inclining edge 926. The second protruding edge 924 of each detecting terminal 9 is corresponding to the second curve portion 24 of the one power terminal 2111 along the transverse direction. The second connecting edge 925 and the second inclining edge 926 of each detecting terminal 9 are corresponding to the first fastening portion 213 of the one power terminal 2111.

Referring to FIG. 4 to FIG. 6, an inside of the first curve portion 23 of each of the two signal terminals 2112 forms a lacking groove 217. The one side edge of the detecting portion 92 of each detecting terminal 9 is received in the lacking groove 217 of the one signal terminal 2112. The lacking groove 217 of each of the two signal terminals 2112 is corresponding to the first inclining edge 923 of the one detecting terminal 9. A first gap 101 is formed between a wall of the lacking groove 217 of each of the two signal terminals 2112 and the first inclining edge 923 of the one detecting terminal 9 which are adjacent to each other. A second gap 102 is formed between each power terminal 2111 and the detecting portion 92 of the one detecting terminal 9 which are adjacent to each other. A third gap 103 is formed between two facing walls of the two adjacent signal terminals 2112 of each side of the upper terminal assembly 21. Therefore, the first gap 101 is bigger than the second gap 102. The first gap 101 is bigger than the third gap 103. In the concrete implementation, the first gap 101 is able to be equal to the second gap 102. A width of the lacking groove 217 of each of the two signal terminals 2112 is able to be wider than or be equal to the third gap 103. The first gap 101 is able to be equal to the third gap 103.

Two middles of two outer surfaces of the two grounding terminals 2110 are bent downward and outward, and then are bent outward to form two first wings 2113. The two first wings 2113 are fastened to a corresponding mechanism of the center grounding plate 3 to realize that the upper terminal assembly 21 is located to the center grounding plate 3, and the upper terminal assembly 21 is fixed to the center grounding plate 3.

The insulating body 212 has a main body 2121, a connecting portion 2122 and a tongue portion 2123. A middle of a front end of the main body 2121 extends frontward to form the connecting portion 2122. A front end of the connecting portion 2122 extends frontward to form the tongue portion 2123. The contacting portion 214 is exposed to an outer surface of the tongue portion 2123. A front end of the detecting portion 92 is exposed to a rear end of the outer surface of the tongue portion 2123, and the rear end of the detecting portion 92 is mounted in the protruding board 12. The first fastening portions 213 of the plurality of the conductive terminals 211 are fastened in the main body 2121 and the connecting portion 2122 of the insulating body 212, and the first fastening portions 213 of the plurality of the conductive terminals 211 are surrounded by the main body 2121 and the connecting portion 2122 of the insulating body 212. The contacting portions 214 of the plurality of the conductive terminals 211 are fastened in the tongue portion 2123 of the insulating body 212, and the contacting portions 214 of the plurality of the conductive terminals 211 are surrounded by the tongue portion 2123 of the insulating body 212. The first soldering portions 215 of the plurality of the conductive terminals 211 project beyond a bottom surface of a rear end of the main body 2121 of the insulating body 212.

Referring to FIG. 1 to FIG. 6, a middle of the main body 2121 of the insulating body 212 has a first penetrating groove 2124 penetrating through middles of a top surface and a bottom surface of the main body 2121. The first penetrating groove 2124 is located at a rear end of the base body 11 of the insulating housing 1. When the electrical connector 100 proceeds a dispensing glue process to seal the electrical connector 100, the first penetrating groove 2124 is used for flowing a glue conveniently. A top surface of the main body 2121 extends upward to form a location block 2125. Two sides of a front end of the top surface of the main body 2121 extend upward to form two location blocks 2125. The two location blocks 2125 are disposed in the base body 11 of the insulating housing 1. The two location blocks 2125 are fastened in a corresponding section of one shielding plate 4 to realize that the upper terminal assembly 21 is located to the one shielding plate 4, and the upper terminal assembly 21 is fixed to the one shielding plate 4. A middle of a front end of the bottom surface of the main body 2121 extends downward to form a location pillar 2120. The location pillar 2120 is buckled with a corresponding section of the center grounding plate 3 to realize that the upper terminal assembly 21 is located to the center grounding plate 3, and the upper terminal assembly 21 is fixed to the center grounding plate 3.

The connecting portion 2122 of the insulating body 212 is disposed in the protruding board 12 of the insulating housing 1. Several portions of a top surface of the connecting portion 2122 extend upward to form a plurality of supporting portions 2126. When the insulating housing 1 is formed, the plurality of the supporting portions 2126 are used for supporting corresponding positions of the one shielding plate 4 to avoid the encapsulation problem of the one shielding plate 4. The plurality of the supporting portions 2126 are disposed in the plurality of the through holes 13 of the insulating housing 1. A middle of the insulating body 212 has a perforation 2127 penetrating through middles of a top surface and a bottom surface of the insulating body 212. The perforation 2127 is formed between the connecting portion 2122 and the tongue portion 2123. The perforation 2127 is formed among the plurality of the supporting portions 2126. When the insulating body 212 and the insulating housing 1 are molded by an injection molding technology, the perforation 2127 is filled up, the perforation 2127 is used for avoiding the plurality of the conductive terminals 211 from being deformed, so that a combination between the insulating body 212 and the insulating housing 1 is enhanced, correspondingly, a combination between a first time molding and a second time molding is enhanced.

Two sides of the tongue portion 2123 have two openings 2128 penetrating through a top surface and a bottom surface of the tongue portion 2123. The two openings 2128 are located in front of the perforation 2127. The two openings 2128 are corresponding to the two detecting terminals 9. In a manufacturing process, two mold elements pass through the two openings 2128, and then the two mold elements support the two detecting portions 92 of the two detecting terminals 9, so the two mold elements prevent the two detecting portions 92 of the two detecting terminals 9 from moving downward. The two detecting portions 92 of the two detecting terminals 9 shield the two openings 2128. The two openings 2128 are used for avoiding the two detecting portions 92 of the two detecting terminals 9 from being deformed. Two sides of the bottom surface of the tongue portion 2123 of the insulating body 212 extend downward to form two fastening blocks 2129. The two fastening blocks 2129 are used for being buckled with corresponding segments of the center grounding plate 3, so that the center grounding plate 3 is located to the upper terminal assembly 21, and the center grounding plate 3 is fixed to the upper terminal assembly 21.

A middle of a front end of the base body 11 of the insulating housing 1 extends frontward to form the protruding board 12 of the insulating housing 1. The tongue portion 2123 of the upper terminal assembly 21 projects beyond a front end of the protruding board 12 of the insulating housing 1. The plurality of the contacting portions 214 of the plurality of the conductive terminals 211 of the upper terminal assembly 21 are disposed to the top surface of the tongue portion 2123 of the upper terminal assembly 21. The two detecting portions 92 of the two detecting terminals 9 are disposed to a rear end of the top surface of the tongue portion 2123 of the upper terminal assembly 21. The two detecting portions 92 of the two detecting terminals 9 are disposed to the front end of the protruding board 12.

Furthermore, the two detecting portions 92 of the two detecting terminals 9 of the upper terminal assembly 21 are disposed between a front end of the top surface of the tongue portion 2123 of the upper terminal assembly 21 and the front end of the protruding board 12. Front ends of the two detecting portions 92 of the two detecting terminals 9 are disposed to the rear end of the top surface of the tongue portion 2123 of the upper terminal assembly 21, and the front ends of the two detecting portions 92 of the two detecting terminals 9 are exposed out of the frond end of the protruding board 12. The rear ends of the two detecting portions 92 of the two detecting terminals 9 are disposed to a front end of the top surface of the connecting portion 2122, and the rear ends of the two detecting portions 92 of the two detecting terminals 9 are covered by the front end of the protruding board 12.

When water flows into the electrical connector 100, the electric capacity of the electrical connector 100 is increased. When each detecting terminal 9 detects that the electric capacity of the electrical connector 100 is changed, the electrical connector 100 stops charging or transmitting signals, so the electrical connector 100 stops working under a condition of the water entering the electrical connector 100 to protect the electrical connector 100.

Referring to FIG. 1 to FIG. 10, the center grounding plate 3 has a second penetrating groove 31, two first location holes 32, a second location hole 33, two inserting holes 34, two inserting slots 35 and two second wings 36. The second penetrating groove 31 penetrates through a top surface and a bottom surface of the center grounding plate 3. The second penetrating groove 31 is corresponding to the first penetrating groove 2124 of the insulating body 212 of the upper terminal assembly 21 of the terminal assembly 2. The second penetrating groove 31 is located to the rear end of the base body 11 of the insulating housing 1. When the electrical connector 100 proceeds the dispensing glue process to seal the electrical connector 100, the second penetrating groove 31 is used for flowing the glue conveniently.

The two first location holes 32 and the second location hole 33 penetrate though the top surface and the bottom surface of the center grounding plate 3. The location pillar 2120 of the insulating body 212 of the upper terminal assembly 21 is fastened in the second location hole 33, so that the upper terminal assembly 21 is located to the center grounding plate 3, and the upper terminal assembly 21 is fixed to the center grounding plate 3.

The two inserting holes 34 penetrate through the top surface and the bottom surface of the center grounding plate 3. The two inserting holes 34 are corresponding to the two detecting portions 92 of the two detecting terminals 9 of the upper terminal assembly 21. The two inserting holes 34 prevent the two detecting terminals 9 of the upper terminal assembly 21 contacting the center grounding plate 3 to cause a short circuit. The two inserting holes 34 are corresponding to the two openings 2128 of the insulating body 212 of the upper terminal assembly 21.

The two inserting slots 35 penetrate through the top surface and the bottom surface of the center grounding plate 3. The two fastening blocks 2129 of the upper terminal assembly 21 are fastened in the two inserting slots 35 to realize that the upper terminal assembly 21 is located to the center grounding plate 3, and the upper terminal assembly 21 is fixed to the center grounding plate 3. Two opposite sides of a middle of the center grounding plate 3 extend outward to form the two second wings 36, respectively. The two first wings 2113 of the upper terminal assembly 21 are soldered to two front ends of two top surfaces of the two second wings 36, respectively.

Referring to FIG. 3, the two shielding plates 4 include an upper shielding plate 41 and a lower shielding plate 42. The upper shielding plate 41 is mounted on the upper terminal assembly 21. The lower shielding plate 42 is mounted under the lower terminal assembly 22. The upper shielding plate 41 is corresponding to the first fastening portions 213 of the upper terminal assembly 21. The upper shielding plate 41 has at least one upper location hole 411 and two upper soldering pieces 412. Specifically, the upper shielding plate 41 has two upper location holes 411. The two upper location holes 411 penetrate through a top surface and a bottom surface of the upper shielding plate 41. The two location blocks 2125 of the upper terminal assembly 21 are fastened in two upper location holes 411 to realize that the upper terminal assembly 21 is located to the shielding plate 4, and the upper terminal assembly 21 is fixed to the shielding plate 4. Two opposite sides of the upper shielding plate 41 are bent downward and then extend outward to form the two upper soldering pieces 412, respectively. The two upper soldering pieces 412 are soldered to two rear ends of the two top surfaces of the two second wings 36 of the center grounding plate 3.

The lower shielding plate 42 has at least one lower location hole 421 and two lower soldering pieces 422. Specifically, the lower shielding plate 42 has two lower location holes 421. The two lower location holes 421 penetrate through a top surface and a bottom surface of the lower shielding plate 42. Two middles of two opposite sides of the lower shielding plate 42 are bent upward and then extend outward to form the two lower soldering pieces 422, respectively. The two lower soldering pieces 422 are soldered to two rear ends of two bottom surfaces of the two second wings 36 of the center grounding plate 3.

Referring to FIG. 4 to FIG. 9, a structure of the lower terminal assembly 22 is roughly the same as a structure of the upper terminal assembly 21. The lower terminal assembly 22 is mounted under the upper terminal assembly 21. The lower terminal assembly 22 is matched with the upper terminal assembly 21. The two middles of the two outer surfaces of the two grounding terminals 2110 are bent upward and outward, and then are bent outward to form another two first wings 2113. Two sides of the front end of the bottom surface of the main body 2121 of the lower terminal assembly 22 extend downward to form another two location blocks 2125. Several portions of a bottom surface of the connecting portion 2122 extend downward to form the plurality of the supporting portions 2126 of the lower terminal assembly 22. The two sides of the front end of the top surface of the main body 2121 of the lower terminal assembly 22 extend upward to form two location pillars 2120. Two sides of the top surface of the tongue portion 2123 of the insulating body 212 extend upward to form another two fastening blocks 2129.

The plurality of the supporting portions 2126 of the lower terminal assembly 22 are disposed in the plurality of the through holes 13 of the insulating housing 1. The two fastening blocks 2129 of the lower terminal assembly 22 are fastened in the two inserting slots 35, and the two location pillars 2120 of the lower terminal assembly 22 are fastened in the two first location holes 32 of the center grounding plate 3, so that the lower terminal assembly 22 is located to the center grounding plate 3, and the lower terminal assembly 22 is fixed to the center grounding plate 3. The location pillars 2120 of the terminal assembly 2 are fastened in the two first location holes 32 and the second location hole 33 to realize that the terminal assembly 2 is located to the center grounding plate 3, and the terminal assembly 2 is fixed to the center grounding plate 3. The contacting portions 214 of the lower terminal assembly 22 are disposed to the bottom surface of the tongue portion 2123 of the lower terminal assembly 22. The detecting portions 92 of the two detecting terminals 9 of the lower terminal assembly 22 are disposed to a rear end of the bottom surface of the tongue portion 2123 of the lower terminal assembly 22. The two inserting holes 34 are corresponding to the two detecting portions 92 of the two detecting terminals 9 of the lower terminal assembly 22. The two inserting holes 34 prevent the two detecting terminals 9 of the lower terminal assembly 22 from contacting the center grounding plate 3. The two first wings 2113 of the lower terminal assembly 22 are soldered to two front ends of the two bottom surfaces of the two second wings 36, respectively, so that the terminal assembly 2 is located to the center grounding plate 3, and the terminal assembly 2 is fixed to the center grounding plate 3. The lower shielding plate 42 is corresponding to the first fastening portions 213 of the lower terminal assembly 22. The two location blocks 2125 of the lower terminal assembly 22 are fastened in the two lower location holes 421 to realize that the lower terminal assembly 22 is located to the lower shielding plate 42, and the lower terminal assembly 22 is fixed to the lower shielding plate 42. The lower terminal assembly 22 is without being described in detail.

As described above, the two detecting terminals 9 are disposed between the two power terminals 2111, the detecting portion 92 of each detecting terminal 9 is shown as the elliptical plate shape for increasing the detecting area and increasing the detecting effect. Furthermore, when the water flows into the electrical connector 100, the electric capacity of the electrical connector 100 is increased. when each detecting terminal 9 detects that the electric capacity of the electrical connector 100 is changed, the electrical connector 100 stops charging or transmitting the signals, so the electrical connector 100 stops working under the condition of the water entering the electrical connector 100 to protect the electrical connector 100. As a result, the electrical connector 100 has a higher detection sensitivity and a better safety protection performance so as to effectively protect the electrical connector 100 and a user.

What is claimed is:

1. An electrical connector, comprising:
an insulating housing;
a plurality of conductive terminals fastened in the insulating housing, each conductive terminal having a first fastening portion, a front end of the first fastening portion extending frontward to form a contacting portion, the contacting portion being exposed to a front end of the insulating housing, the plurality of the conductive terminals including two power terminals and a plurality of signal terminals, two first curve portions being formed between two front ends of the two first fastening portions of two signal terminals and two rear ends of the two contacting portions of the two signal terminals, two second curve portions being formed between the two rear ends of the two contacting portions and the two front ends of the two first fastening portions of the two power terminals; and
two detecting terminals fastened in the insulating housing, each detecting terminal being disposed between one signal terminal and one power terminal, each detecting terminal having a second fastening portion, a front end of the second fastening portion extending frontward and expanding outward to form a detecting portion, the detecting portion being exposed to the front end of the insulating housing, two rear ends of the two second fastening portions of the two detecting terminals and rear ends of the plurality of the first fastening portions of the plurality of the conductive terminals being aligned along a transverse direction, the front ends of the two second fastening portions of the two detecting terminals being corresponding to the front ends of the plurality of the first fastening portions of the plurality of the conductive terminals along the transverse direction, the two detecting portions of the two detecting terminals being disposed corresponding to rear ends of the plurality of the contacting portions of the plurality of the conductive terminals along the transverse direction, two opposite sides of the detecting portion of each detecting terminal being located between the first curve portion of the one signal terminal and the second curve portion of the one power terminal, the first curve portion and the second curve portion which are located to the two opposite sides of the detecting portion of each detecting terminal being disposed opposite to each other along the transverse direction.

2. The electrical connector as claimed in claim 1, wherein two fronts of the two rear ends of the two contacting portions of the two signal terminals slantwise extend rearward and away from the two detecting terminals to form two first bending portions, two rear ends of the two first bending portions extend rearward to form two extending portions, two rear ends of the two extending portions slantwise extend rearward and away from the two first bending portions to form two second bending portions, two rear ends of the two second bending portions extend rearward to form the two first fastening portions of the two signal terminals, the first bending portion, the extending portion and the second bending portion together form the first curve portion.

3. The electrical connector as claimed in claim 2, wherein the first bending portion, the extending portion and the second bending portion of the first curve portion is shown as a C shape.

4. The electrical connector as claimed in claim 2, wherein one side edge of the detecting portion of each detecting terminal has a first protruding edge, a first connecting edge and a first inclining edge which are sequentially arranged along a front-to-rear direction, a front end of the one side edge of the detecting portion protrudes towards the first bending portion to form the first protruding edge, a rear end of the first protruding edge extends rearward to form the first connecting edge, a rear end of the first connecting edge slantwise extends rearward and away from the extending portion to form the first inclining edge, the first curve portion of each of the two signal terminals surrounds the one side edge of the detecting portion of one detecting terminal, the first curve portion of each of the two signal terminals is spaced from the one side edge of the detecting portion of the one detecting terminal, the two first protruding edges of the two detecting terminals are corresponding to the two first bending portions, the first connecting edge, the first inclining edge and the front end of the second fastening portion of each detecting terminal are corresponding to the extending portion and the second bending portion of the one signal terminal along the transverse direction, the first connecting edge is parallel to the extending portion, the first inclining edge is parallel to the second bending portion.

5. The electrical connector as claimed in claim 4, wherein the other side edge of the detecting portion has a second protruding edge, a second connecting edge and a second inclining edge which are sequentially arranged along the front-to-rear direction, a front end of the other side edge of the detecting portion protrudes towards the second curve portion to form the second protruding edge, a rear end of the second protruding edge extends rearward to form the second connecting edge, a rear end of the second connecting edge slantwise extends rearward and away from the second curve portion to form the second inclining edge, the second protruding edge of each detecting terminal is corresponding to the second curve portion of the one power terminal along the transverse direction, the second connecting edge and the second inclining edge of each detecting terminal are corresponding to the first fastening portion of the one power terminal.

6. The electrical connector as claimed in claim 4, wherein an inside of the first curve portion of each of the two signal terminals forms a lacking groove, the one side edge of the detecting portion of each detecting terminal is received in the lacking groove of the one signal terminal, the lacking groove of each of the two signal terminals is corresponding to the first inclining edge of the one detecting terminal, a first gap is formed between a wall of the lacking groove of each of the two signal terminals and the first inclining edge of the one detecting terminal which are adjacent to each other, a second gap is formed between each power terminal and the detecting portion of the one detecting terminal which are adjacent to each other, a third gap is formed between two facing walls of the two adjacent signal terminals, the first gap is bigger than the second gap, the first gap is bigger than the third gap.

7. The electrical connector as claimed in claim 1, wherein two opposite sides of each detecting terminal face towards two side surfaces of the one signal terminal and the one power terminal, two fronts of the two side surfaces of the one signal terminal and the one power terminal are recessed oppositely to form the first curve portion and the second curve portion.

8. The electrical connector as claimed in claim 1, wherein the detecting portion of each detecting terminal is shown as an elliptical plate shape, a width of the detecting portion of each detecting terminal is wider than a width of the second fastening portion of each detecting terminal, the width of the detecting portion of each detecting terminal is wider than a width of the contacting portion of each conductive terminal, the width of the detecting portion of each detecting terminal is wider than a width of the first fastening portion of each conductive terminal.

9. The electrical connector as claimed in claim 1, wherein the insulating housing has a base body, a middle of a front surface of the base body extends frontward to form a protruding board, an insulating body is mounted in the insulating housing, the insulating body has a main body, a middle of a front end of the main body extends frontward to form a connecting portion, a front end of the connecting portion extends frontward to form a tongue portion, the tongue portion projects beyond a front end of the protruding board, the plurality of the contacting portions of the plurality of the conductive terminals are disposed to a top surface of the tongue portion, the two detecting portions of the two detecting terminals are disposed to a rear end of the top surface of the tongue portion, the two detecting portions of the two detecting terminals are disposed to the front end of the protruding board.

10. The electrical connector as claimed in claim 1, wherein the rear ends of the plurality of the contacting portions of the plurality of the conductive terminals are aligned along the transverse direction, the front ends of the plurality of the contacting portions of the plurality of the conductive terminals are corresponding to one another along the transverse direction, the rear ends of the plurality of the first fastening portions of the plurality of the conductive terminals are aligned along the transverse direction, the front ends of the plurality of the first fastening portions of the plurality of the conductive terminals are corresponding to one another along the transverse direction.

11. The electrical connector as claimed in claim 1, wherein a rear end of the first fastening portion extends downward and then is bent rearward to form a first soldering portion, the plurality of the first soldering portions of the plurality of the conductive terminals are aligned along the transverse direction, a rear end of the second fastening portion extends downward and then is bent rearward to form a second soldering portion, the two second soldering portions of the two detecting terminals and the plurality of the first soldering portions of the plurality of the conductive terminals are aligned along the transverse direction.

12. An electrical connector, comprising:
an insulating housing having a tongue portion, a protruding board and a base body arranged along an insertion direction;
a plurality of conductive terminals arranged in a column along a transverse direction, the plurality of the conductive terminals being fastened in the base body, the plurality of the conductive terminals being exposed to the tongue portion; and
two detecting terminals fastened in the base body, the two detecting terminals being disposed among the plurality of the conductive terminals, the two detecting terminals being arranged in the column, edges of the two detecting terminals facing edges of adjacent conductive terminals, each detecting terminal having a detecting portion, a front of the detecting portion being exposed to the tongue portion, a rear of the detecting portion hidden in the protruding board, a width of the detecting portion of each detecting terminal being wider than a width of each conductive terminal;
wherein at least one of the conductive terminals which is adjacent to each of the two detecting terminals has a lacking groove avoiding the detecting portion, a front of the lacking groove is exposed to the tongue portion, a rear of the lacking groove is hidden in the protruding board.

13. The electrical connector as claimed in claim 12, wherein the plurality of the conductive terminals include two power terminals and a plurality of signal terminals, each detecting terminal is disposed between one signal terminal and one power terminal, two opposite sides of each detecting terminal face towards two side surfaces of the one signal terminal and the one power terminal, two fronts of the two side surfaces of the one signal terminal and the one power terminal are recessed oppositely to form a first curve portion and a second curve portion, two opposite sides of the detecting portion of each detecting terminal are located between the first curve portion of the one signal terminal and the second curve portion of the one power terminal, the first curve portion and the second curve portion which are located to the two opposite sides of the detecting portion of each detecting terminal are disposed opposite to each other along the transverse direction, the first curve portion surrounds the lacking groove.

14. The electrical connector as claimed in claim 13, wherein the two first curve portions are formed between two front ends of two first fastening portions of the two signal terminals and two rear ends of the two contacting portions of the two signal terminals, the two second curve portions are formed between two rear ends of two contacting portions and two front ends of two first fastening portions of the two power terminals.

15. The electrical connector as claimed in claim 13, wherein two fronts of two rear ends of two contacting portions of the two signal terminals slantwise extend rearward and away from the two detecting terminals to form two first bending portions, two rear ends of the two first bending portions extend rearward to form two extending portions, two rear ends of the two extending portions slantwise extend rearward and away from the two first bending portions to form two second bending portions, two rear ends of the two second bending portions extend rearward to form two first fastening portions of the two signal terminals, the first bending portion, the extending portion and the second bending portion together form the first curve portion, the two first bending portions are exposed to the tongue portion, the two second bending portions are hidden in the protruding board.

16. The electrical connector as claimed in claim 15, wherein one side edge of the detecting portion of each detecting terminal has a first protruding edge, a first connecting edge and a first inclining edge which are sequentially arranged along a front-to-rear direction, a front end of the one side edge of the detecting portion protrudes towards the first bending portion to form the first protruding edge, a rear end of the first protruding edge extends rearward to form the first connecting edge, a rear end of the first connecting edge slantwise extends rearward and away from the extending portion to form the first inclining edge, the first curve portion surrounds the one side edge of the detecting portion of one detecting terminal, the first curve portion is spaced from the one side edge of the detecting portion of the one detecting terminal, the two first protruding edges of the two detecting terminals are corresponding to the two first bending portions, the first connecting edge, the first inclining edge and a front end of the second fastening portion of each detecting terminal are corresponding to the extending portion and the second bending portion of the one signal terminal along the transverse direction, the first connecting edge is parallel to the extending portion, the first inclining edge is parallel to the second bending portion, the first protruding edge is exposed to the tongue portion, the first inclining edge is hidden in the protruding board.

17. The electrical connector as claimed in claim 16, wherein the other side edge of the detecting portion has a second protruding edge, a second connecting edge and a second inclining edge which are sequentially arranged along the front-to-rear direction, a front end of the other side edge of the detecting portion protrudes towards the second curve portion to form the second protruding edge, a rear end of the second protruding edge extends rearward to form the second connecting edge, a rear end of the second connecting edge slantwise extends rearward and away from the second curve portion to form the second inclining edge, the second protruding edge of each detecting terminal is corresponding to the second curve portion of the one power terminal along the transverse direction, the second connecting edge and the second inclining edge of each detecting terminal are corresponding to the first fastening portion of the one power terminal, the second protruding edge is exposed to the tongue portion, the second inclining edge is hidden in the protruding board.

18. An electrical connector, comprising:
an insulating housing having a base body and a tongue portion;
a plurality of conductive terminals fastened in the base body, the plurality of the conductive terminals being exposed to the tongue portion, the plurality of the conductive terminals having a plurality of upper terminals and a plurality of lower terminals, the plurality of the upper terminals and the plurality of the lower terminals being arranged in two columns along a transverse direction;
a center grounding plate fastened in the base body and the tongue portion, the center grounding plate being disposed between the plurality of the upper terminals and the plurality of the lower terminals, the center grounding plate having two inserting holes, the two inserting holes penetrating through opposite surfaces of the center grounding plate; and
two detecting terminals arranged in each column of the conductive terminals, each detecting terminal having a detecting portion being exposed to the tongue portion;
wherein the two detecting portions of the two detecting terminals in the column of the plurality of the upper terminals align with the two detecting portions of the two detecting terminals in the column of the plurality of the lower terminals through the two inserting holes;
wherein a width of the detecting portion of each detecting terminal is wider than a width of each conductive terminal.

19. The electrical connector as claimed in claim 18, wherein at least one of the conductive terminals which is adjacent to each of the detecting terminals has a lacking groove, the lacking groove is avoided the detecting portion, the insulating housing has a protruding board between the base body and the tongue portion, a front of the lacking groove is exposed to the tongue portion, a rear of the lacking groove is hidden in the protruding board, a front of the detecting portion is exposed to the tongue portion, a rear of the detecting portion is hidden in the protruding board.
